(19) United States
(12) Patent Application Publication
(10) Pub. No.: US 2024/0378809 A1
(43) Pub. Date: Nov. 14, 2024

(54) DIGITAL IMAGE DECALING

(71) Applicant: Adobe Inc., San Jose, CA (US)

(72) Inventors: Yangtuanfeng Wang, London (GB); Yi Zhou, San Jose, CA (US); Yasamin Jafarian, Minneapolis, MN (US); Nathan Aaron Carr, San Jose, CA (US); Jimei Yang, Mountain View, CA (US); Duygu Ceylan Aksit, London (GB)

(73) Assignee: Adobe Inc., San Jose, CA (US)

(21) Appl. No.: 18/316,490

(22) Filed: May 12, 2023

(51) Int. Cl. G06T 17/20

(52) U.S. Cl. CPC G06T 17/20; G06T 2210/16; G06T 2210/44

(57) ABSTRACT

Decal application techniques as implemented by a computing device are described to perform decaling of a digital image. In one example, learned features of a digital image using machine learning are used by a computing device as a basis to predict the surface geometry of an object in the digital image. Once the surface geometry of the object is predicted, machine learning techniques are then used by the computing device to configure an overlay object to be applied onto the digital image according to the predicted surface geometry of the overlaid object.

### BACKGROUND

Decaling may be used by a computing device to support a variety of digital image processing. In one example, an object depicted in a portion of a digital image is modified to have a different pattern, color, logo, or texture. Thus, decaling may be used by a computing device to modify an appearance of an object in a digital image without the need to capture a new image of a similar physical object having the modified appearance.

Conventional techniques to perform decaling are faced with numerous challenges. Initially, decaling techniques were developed in which a decal is generated by a computing device by ignoring the local geometry of the object and simply overlaying the portion of the image that includes the object with a different color or pattern. Although these techniques functioned well for digital images having simple object geometries, these techniques often failed and thus looked unrealistic for structured or complex object geometries (e.g., articles of clothing, garments, etc.).

### SUMMARY

Digital image decaling techniques as implemented by a computing device are described to perform decaling of a digital image. In one example, learned features of a digital image using machine learning are used by a computing device as a basis to predict the surface geometry of an object in a digital image. Once the surface geometry of the object is predicted, machine learning techniques are then used by the computing device to insert an overlay object into the digital image according to the predicted surface geometry.

To do so, a surface map is generated by a computing device processing one or more digital images of objects belonging to a same category of objects as the object in the digital image that is to be decaled. The surface map describes respective features to each other between the one or more digital images and a three-dimensional (3D) object model (e.g., mesh template) associated with the category of objects.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ digital image decaling techniques described herein.

FIGS. 2 and 3 depict examples of a system to generate training digital images to train a neural network of a machine learning system to generate a surface map.

FIG. 4 is a flow diagram depicting a procedure in an example implementation of generation of annotation data usable to train a model using machine learning to generate a surface map.

FIG. 5 depicts a system in an example implementation showing operation of a machine learning system for training a model using a digital image and annotation data for generating surface maps.

FIG. 6 is a flow diagram depicting a procedure in an example implementation of training a model using machine learning to generate a surface map.

FIG. 7 depicts a system in an example implementation showing operation of a machine learning system of FIG. 1 in greater detail as generating a surface map for a digital image by a model trained using training digital images of FIGS. 2-6.

FIG. 8 depicts a system in an example implementation showing operation of a machine learning system of FIG. 1 in greater detail as decaling a digital image based on a surface map generated by a model of FIG. 7.

FIG. 9 is a flow diagram depicting a procedure in an example implementation in which surface normals are estimated for an object in a digital image and used with a surface map to decal the digital image according to the surface geometry of the object.

FIG. 10 depicts a system in an example implementation showing different types of decal application modes based on a surface map generated using machine learning.

FIG. 11 illustrates an example system including various components of an example device that can be implemented as any type of computing device as described and/or utilize with reference to FIGS. 1-10 to implement embodiments of the techniques described herein.

### DETAILED DESCRIPTION

### Overview

Conventional techniques used by a computing device to decal or otherwise change an appearance of an object in a digital image are confronted with a variety of challenges that may cause a decaled image to look unrealistic. Conventional decal techniques, for instance, initially overlayed content included in other images or decal input data onto a digital image without accounting for the local geometry of the object depicted in the image. Although these initial conventional decal techniques may operate well for digital images having simple surface geometries, these techniques may look unrealistic for digital images having complex and/or flexible object geometries (e.g., garments, articles of clothing, etc.).

In another example, subsequent conventional decal techniques rely on manual annotations prepared by an expert (e.g., a UV map) that describe a generic surface geometry for objects similar to the object that is to be decaled. However, these conventional decal techniques may fail because it is often difficult in practice to find other surface maps (e.g., from a stock UV map repository) that entirely match the content in the digital image that is to be decaled (e.g., a generic UV map for shirts may not entirely correspond to the specific shirt in the digital image). For example, eighty percent of the boundary of the object in the digital image may match the shape of the generic UV map, but the rest of the digital image may not match and may thus look unrealistic. Alternatively, subsequent conventional decal techniques may rely on the expert to manually annotate or optimize a UV map specifically for each digital image that is to be decaled. However, these conventional decal techniques may be impractical, time consuming, computationally expensive, and/or provide inconsistent results. In both cases, this may cause the overall result to look unrealistic and thus fail for its intended purpose.

Accordingly, decal techniques are described that are usable to overlay an overlay object (also referred to as a “decal” in the following discussion) onto a digital image in an improved and computationally efficient manner over conventional techniques. In one example, learned features of a digital image using machine learning are used by a computing device as a basis to overlay a decal (e.g., color, pattern, texture, logo, insertion image, insertion text, etc.) onto the digital image.

The features, for instance, may be extracted from a neural network as activations used to describe aspects of an object in the digital image. These features may then be used as a basis for predicting a surface geometry of the object (e.g., edges, wrinkles, curves, etc.) as it is depicted in the digital image. In this way, surface geometries of thousands and even millions of objects depicted in digital images may be predicted, automatically and without user intervention, by a computing device. Further, this may be performed in real time to predict a surface geometry that is a “best fit” to the appearance of complex or flexible objects in the digital image, which is not possible to be performed manually by a human being. For example, a flexible object (e.g., garment) when worn by a person in one digital image may appear to have different local geometries (e.g., wrinkles, etc.) than when the same object is worn by the same or different person in a different image.

Once predicted, machine learning techniques are then used to map a decal (e.g., texture, color, pattern, insertion image, insertion text, logo, etc.) with the surface geometry of the object in the digital image. A computing device, for instance, may map pixel locations of the object in the digital image to corresponding positions on a surface of a three-dimensional (3D) object model template rendered for the object. This mapping (e.g., UV map), for instance, can be used by the computing device as a basis to “wrap” the texture of the decal onto the surface of the 3D object model in a manner consistent with the predicted surface geometry of the object in the digital image.

Once mapped, the mapping is then used to overlay the decal onto the digital image according to the surface geometry (e.g., wrinkles, etc.) of the object. For example, the overlayed object may be mapped to simulate its projection onto a 3D surface of the object. Accordingly, in the techniques described herein machine learning techniques are used to determine which parts of the decal (e.g., insertion image, texture, pattern, etc.) are to be mapped or transferred onto which pixels of the digital image while remaining faithful to the underlying geometry of the object as it is depicted in the digital image.

To do so, a surface map (e.g., UV map) is generated by processing the digital image using a neural network by a computing device. The surface map maps (or “unwraps”) pixel positions in the portion of the digital image that includes the object to points on a 3D surface. Thus, the surface map may be used to describe which parts (e.g., pixels) of the decal image (or other decal data) are to be used as a basis to overlay (or “wrap”) the decal onto the portion of the digital image that includes the object, consistent with the surface geometry of the object. In this way, the digital image is decaled automatically and without user intervention by the computing device in a computationally efficient manner over conventional techniques to have a realistic decal.

Techniques are also described to train the neural network to generate the surface map. In one example, a digital image is selected from an image repository or otherwise input to a computing device. The digital image includes an object (e.g., image depicting a person wearing a garment, etc.) that belongs to a category of objects (e.g., skirt, shirt, trousers, etc.). The computing device also selects or receives object model data (e.g., mesh template, 3D object model template, etc.) associated with a same category of objects as the object depicted in the digital image.

In an implementation, the computing device uses the object model data to render a view of the object (e.g., front view) and to select a plurality of anchor points (e.g., points along the edge of the object) along a surface of the template object. In an example, the computing device generates a reference surface map (e.g., UV map) for the template object. In another example, the computing device renders an adapted version of the 3D object model template according to a shape of the object in the digital image.

In an implementation, the computing device also generates an image mask that indicates a portion of the digital image that includes the object and/or a masked image that corresponds to the portion of the digital image. In an example, the computing device annotates pixel positions in the masked image corresponding to the plurality of anchor points in the rendered 3D object model. For instance, the computing device may distribute the plurality of anchor points along edges of the object depicted in the digital image in a geometrically consistent or proportional manner to the positions along the edges of the rendered template object.

The annotation data (e.g., anchor point locations, mask data, etc.) is then provided to the machine learning system as input for training the neural network. The anchor point locations and other annotation data, for instance, acts to train the neural network to recognize how various portions of the digital image correspond to surface locations (e.g., UV coordinates) along a surface of the 3D object model. In this way, the computing device may annotate a multitude of training digital images (e.g., thousands and even millions) sparsely (e.g., by computing anchor point locations in image space and UV space) in an efficient and accurate manner to train the neural network to generate the surface map automatically and without user intervention by the computing device, which is not possible to be performed by a human being.

In an implementation, the computing device implementing the machine learning system estimates surface normals for at least the portion of the digital image that includes the object. Surface normal estimation generally includes estimating a surface normal vector (e.g., direction of a surface normal) at various pixels. Estimating the surface normals acts as a geometric signal to supervise training the neural network in an accurate and efficient manner, by enforcing a geometric consistency between the estimated surface normals and the predicted surface map.

In the following discussion, an example environment is described that may employ the techniques described herein. Example procedures are also described which may be performed in the example environment as well as other environments. Consequently, performance of the example procedures is not limited to the example environment and the example environment is not limited to performance of the example procedures.

### Example Environment

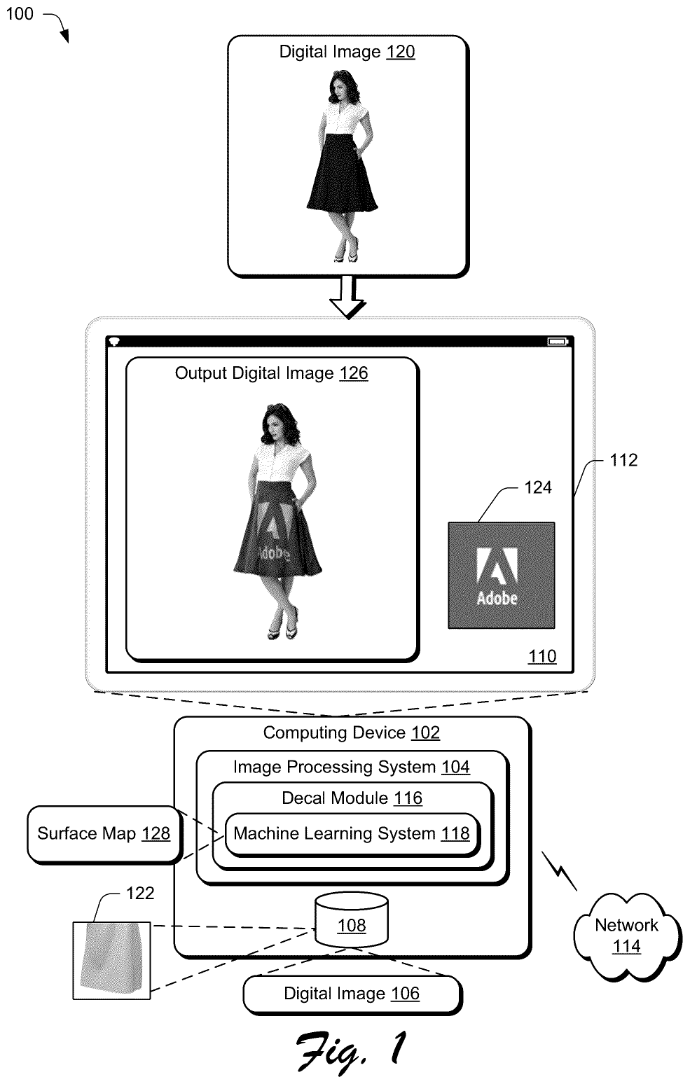

FIG. 1 is an illustration of a digital medium environment 100 in an example implementation that is operable to employ object overlay techniques described herein. The illustrated environment 100 includes a computing device 102, which may be configured in a variety of ways.

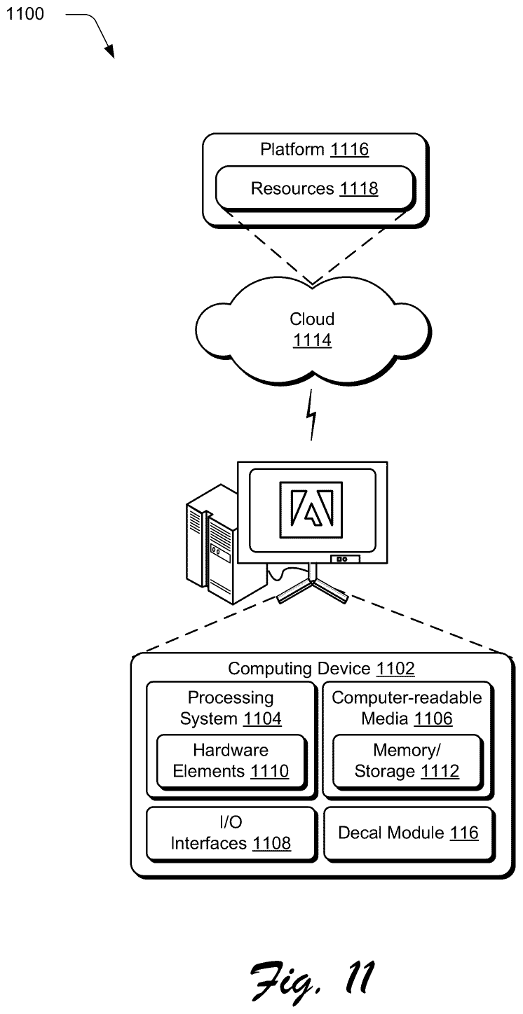

The computing device 102, for instance, may be configured as a desktop computer, a laptop computer, a mobile device (e.g., assuming a handheld configuration such as a tablet or mobile phone as illustrated), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business to perform operations “over the cloud” as described in FIG. 11.

The computing device 102 is illustrated as including an image processing system 104. The image processing system 104 is implemented at least partially in hardware of the computing device 102 to process and transform a digital image 106, which is illustrated as maintained in storage 108 of the computing device 102. Such processing includes creation of the digital image 106, modification of the digital image 106, and rendering of the digital image 106 in a user interface 110 for output, e.g., by a display device 112. Although illustrated as implemented locally at the computing device 102, functionality of the image processing system 104 may also be implemented as whole or part via functionality available via the network 114, such as part of a web service or “in the cloud.”

An example of functionality incorporated by the image processing system 104 to process the image 106 is illustrated as a decal module 116 that includes a machine learning system 118. The decal module 116 implements functionality to receive as an input a digital image 120 that includes an overlay object to be decaled (e.g., retextured, etc.). The overlay object may belong to a category of objects (e.g., skirts), which are associated with object model data (e.g., mesh template or 3D object model template) of a template object (which may be different than an object depicted in the digital image 120). From this, the decal module 116 selects or receives a decal input 124 (e.g., a texture map, an image, a pattern, a logo, a color, text, etc.) and outputs a decaled output digital image 126 automatically and without user intervention. Other examples are also contemplated, such as to support user selection of the decal input 124 to create new types of artwork. The “decaling” of the overlay object (e.g., skirt) in the digital image 120 by the decal module 116 is guided by the decal input 124 using machine learning as performed by the machine learning system 118.

The decal module 116 and associated machine learning system 118 support numerous advantages over conventional techniques used to decal an object in a digital image. For example, the machine learning system 118 may be used to overlay (e.g., “wrap”) the decal input 124 according to the surface geometry of the object (e.g., skirt) depicted in the digital image 120 automatically, as shown in the illustrated example. This is performed by comparing features (e.g., wrinkles, edges, shape, etc.) extracted from the digital image 120 using machine learning with features extracted from training digital images that depict similar objects (e.g., images of persons wearing other skirts, etc.) and which are associated with certain 3D surface positions (e.g., in a reference UV map) relative to one another.

Once the surface geometry of the object is predicted, the machine learning system 118 is configured to wrap or align the decal input 124 with the object in the digital image 120. To do so, a surface map 128 (e.g., UV map) is generated by the machine learning system 118 to describe parameters that specify a translation, rotation, scaling, and/or other mapping of pixels of the decal input 124 with respect to pixels in the digital image 120 corresponding to the object (e.g., skirt). This may be performed also through comparison of features of the digital image 120 and the training images that are extracted through machine learning. In this way, a decal input 124 having content (e.g., two-dimensional (2D) texture map, etc.) that is not initially geometrically aligned with the object in the digital image 120 can be geometrically “wrapped” or warped so that it closely resembles the surface geometry of the object.

Thus, the surface map 128 is also usable to describe which pixels are to be copied from the decal input 124 onto which corresponding pixels of the digital image 120. As previously described, conventional techniques are challenged and find it difficult to produce a 3D object model for each object depicted in a digital image. Further, in conventional techniques is difficult in practice to locate a 3D object model template (e.g., object model data 122) that is an exact match for the object or content in the digital image 120. Further, it may be computationally expensive to develop a new 3D model, especially for flexible objects (e.g., garments) such as the garment in the illustrated example.

The surface map 128 describes similarity of respective features to each other between the digital image 120, similar training images mapped to certain surface map coordinates (e.g., UV coordinates of a rendering of a mesh template). Thus, the surface map 128 may be used to describe which parts (e.g., pixels) of the decal input 124 and the digital image 120 correspond to one another if the decal input 124 is to be overlayed onto in the digital image 120 according to the surface geometry of a certain object in the digital image 120. The shading, shape, and/or mapping position of the various pixels of the decal input 124 when overlayed in the output digital image 126 are adjusted or synthesized by the machine learning system 118 based on the predicted surface geometry of the underlying object, thereby achieving improved realism over conventional decal techniques by preventing or reducing potentially distracting visual artifacts.

The following discussion begins with an example of training a machine learning system 118 to generate a surface map 128 and the generation of training digital images used to do so by a computing device. Operation of the machine learning system 118 to perform decal techniques is then described, which includes generation of a surface map for a digital image, and applying a decal as an overlay object that is consistent with the surface geometry of an overlaid object in the digital image.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

### Training Data Generation

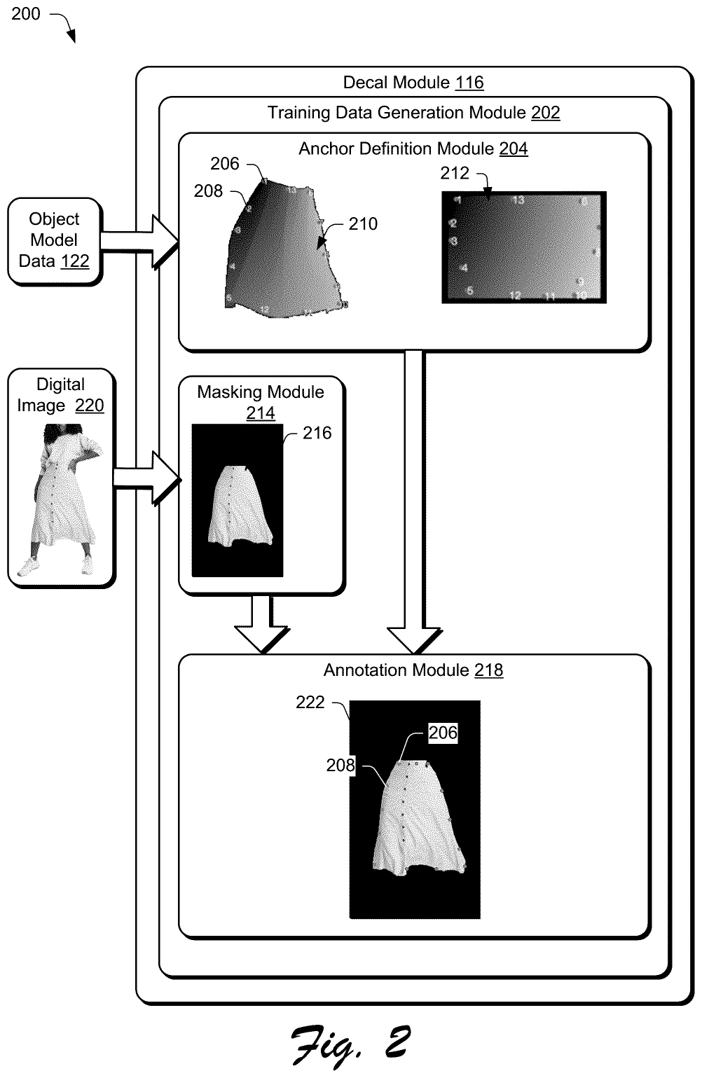

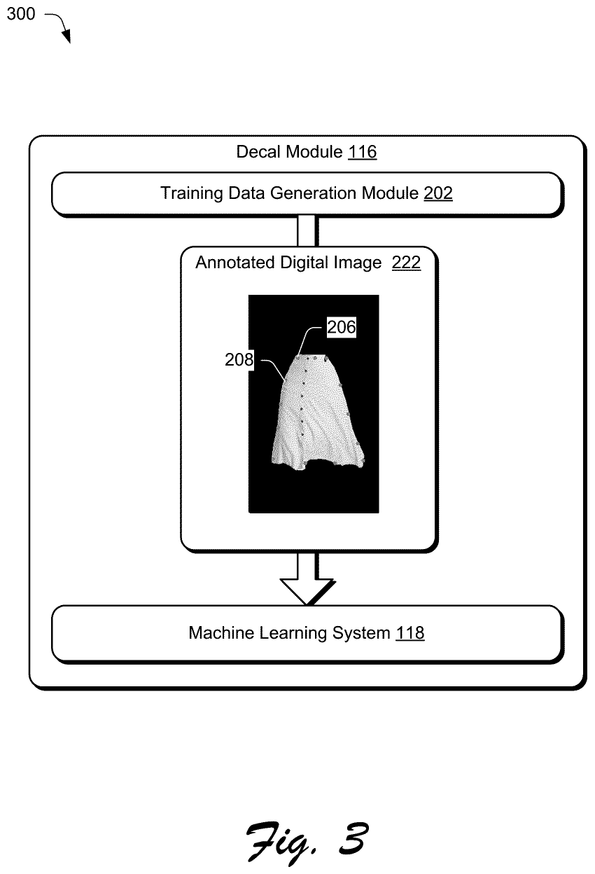

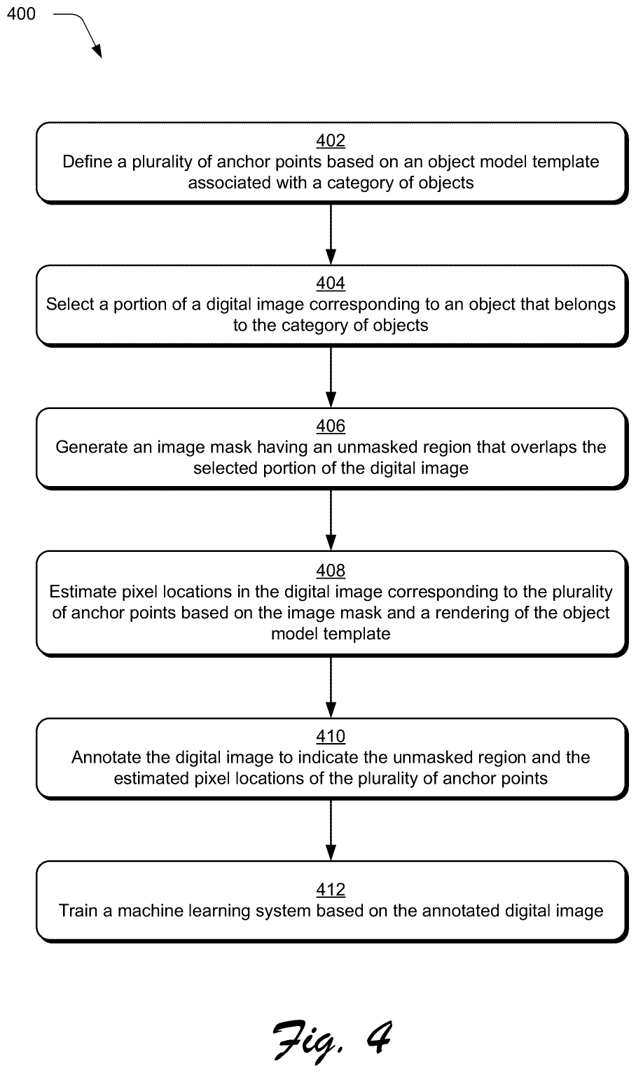

FIGS. 2 and 3 depict examples 200, 300 of a system to annotate digital images for training a neural network of a machine learning system 118 to generate a surface map 128. FIG. 4 depicts a procedure 400 in an example implementation of generation of annotated digital images usable to train a model using machine learning to generate a surface map 128.

The following discussion describes techniques that may be implemented utilizing the described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeably to FIGS. 1-4.

To train a model by the machine learning system (e.g., a neural network) to generate a surface map 128, a digital image 220 depicting an object (e.g., a garment worn by a person) and object model data 122 are processed using a training data generation module 202 as follows. The object model data 122 corresponds to a template object that belongs to a same category (e.g., skirt) as the object in the digital image (e.g., mesh template or 3D template object model).

To begin, an anchor definition module 204 of the training data generation module 202 defines a plurality of anchor points (e.g., anchor points 206 and 208) based on an object model template associated with a category of objects (block 402). As illustrated, the plurality of anchor points is mapped to a reference surface map (e.g., UV map), e.g., having the positions shown in image space 210 and UV space 212. In examples, the surface map 128 includes a UV map that maps points along a 3D surface of 3D object model to UV coordinates in a 2D space (represented by the UV space 212). For instance, the UV space may correspond to a flat or “unwrapped” 2D view of the 3D object (e.g., skirt) described by the object model data 122. In an example, the anchor definition module 204 defines the anchor points 206, 208, etc. by rendering a view of the mesh template (e.g., front view) and selecting the anchor points along edges of the object in the rendered view.

A masking module 214 is then used to select a portion of the digital image 220 corresponding to an object that belongs to the same category of objects as the object of the mesh template (block 404). For example, the masking module 214 may generate an image mask having an unmasked region 216 that overlaps the object (i.e., the selected portion) of the digital image 220 (block 406). In examples, various image segmentation and/or edge detection techniques are employed to generate the image mask and/or select the portion of the portion of the digital image 220 corresponding to the unmasked region 216. It is noted that in the illustrated example, the object in the unmasked region 216 (e.g., skirt) has similar but slightly different appearance aspects (e.g., overall shape, wrinkles, etc.) as compared to the rendered image of the template object, e.g., image space 210.

An annotation module 218 is then used to estimate pixel locations (block 408) in the digital image 220 corresponding to the plurality of anchor points 206, 208, etc., based on the image mask (generated by the masking module 214) and a rendering of the object model template, e.g., the rendering shown in image space 210. For example, as shown in FIG. 2, a relative distribution of the plurality of anchor points 206, 208, etc. shown in annotated digital image 222 is similar to the corresponding positions of the anchor points defined for the template object, e.g., see image space 210. In an implementation, the object model template is adapted and rendered (e.g., by stretching the edges between mesh nodes) to fit the overall shape of the front view of the object (e.g., skirt) depicted in the digital image 220. In other implementations, the computing device attempts to redistribute the anchor points while maintaining pixel distance ratios between the various anchor points. Other implementations are possible.

The annotation module 218 then annotates the digital image 220 (e.g., as the annotated digital image 222) to indicate the unmasked region 216 and the estimated pixel locations of the plurality of anchor points 206, 208, etc. (block 410). In an implementation, the annotation module includes the annotation data in the annotated digital image 222. For example, mask information is saved as an image layer and the anchor points 206, 208, etc., are saved as metadata. In another alternate implementation, the annotation data is stored and/or transmitted (e.g., together with the original digital image 220) separately to the machine learning system 118. The annotation module 218 then provides the annotated digital image 220 to train the machine learning system 118 (block 410).

In some examples, a rendered image of the template object (e.g., front view rendering depicted by the image space 208) and an associated surface map (e.g., UV map depicted in UV space 210) thereof are provided to the machine learning system 118 as a densely annotated training image (e.g., specifying all the UV coordinates for all the pixels in the rendered image 208) in addition to or instead of the annotated digital image 222 of the digital image 220.

### Neural Network Training

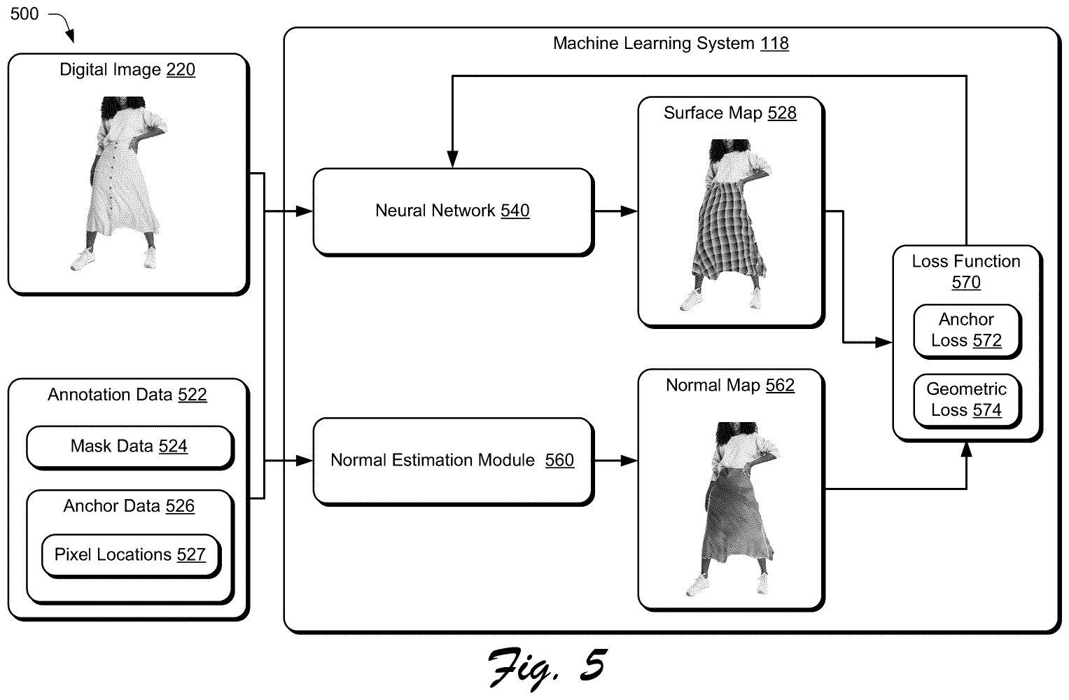

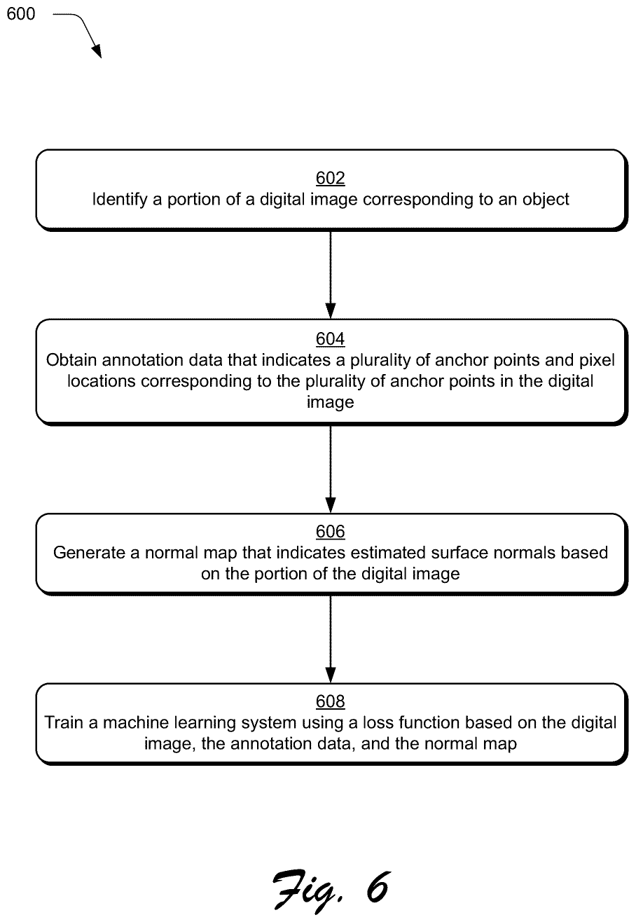

FIG. 5 depicts a system 500 in an example implementation for training a machine learning system 118 to generate a surface map 128. FIG. 6 depicts a procedure 600 in an example implementation in which a surface map is generated using machine learning from a digital image 220 and annotation data 522 associated with the digital image 220.

The following discussion describes techniques that may be implemented utilizing the described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeably to FIGS. 5-6.

The machine learning system 118, as described in relation to FIGS. 2-4, identifies a portion of a digital image 220 corresponding to an object (block 602). For example, the machine learning system 118 obtains annotation data 522 that indicates a plurality of anchor points 206, 208, etc. (e.g., anchor data 526) in the digital image 220 (block 604). In an example, the annotation data 522 also includes pixel locations 527 of the plurality of anchor points 206, 208, etc. For example, the anchor data 522 may include both the pixel locations depicted for the anchor points 206, 208, etc. in the annotated digital image 222 of FIGS. 2-3, and optionally an indication of correspond positions of the anchor points in a reference surface map (e.g., corresponding UV coordinates in UV space 212). In the illustrated example, the annotation data 522 also includes mask data 524, which may include an indication of the portion of the digital image 220 corresponding to the unmasked region 216 (i.e., where the object that is to be decaled is located).

A normal estimation module 560 in the machine learning system 118 then uses the digital image 220 (and optionally the mask data 524) to generate a normal map 562 (block 606) that indicates estimated surface normals based on the identified portion of the digital image 220. For example, the normal map 562 includes pixel values for each pixel in the identified portion of the digital image 220 that indicate a surface normal vector of the object at the respective pixel (e.g., the direction of the surface normal vector at the pixel). Various surface normal estimation techniques can be employed to estimate the surface normal vectors of the normal map 562. For example, convolutional neural networks can be used predict surface normals from the digital image 220.

A neural network 540 then trains the machine learning system 118 to predict a surface map 528 for the object depicted in the digital image 220 using a loss function 570 based on the digital image 220, the annotation data 522, and the normal map 562 (block 608). For example, the neural network 540 extracts features describing aspects of the appearance (e.g., wrinkles, folds, edges, etc.) of the object in the digital image 220 by using the annotation data 522 as a guide to self-supervise its prediction of the surface map 528.

In an implementation, the machine learning system 118 supervises training the neural network 540 by attempting to map image pixels in the digital image 220 to coordinates (e.g., UV coordinates) in the surface map 528 while minimizing an anchor loss 572 of the loss function 570. The anchor loss 572 describes a difference between anchor point locations in the predicted surface map 528 relative to reference anchor point locations in a reference surface map (e.g., the anchor point locations of the template object depicted in the UV space 212).

In an implementation, the machine learning system 118 supervises training the neural network 540 by mapping image pixels in the digital image 220 to coordinates (e.g., UV coordinates) in the predicted surface map 528 while minimizing a geometric loss 574 of the loss function 570. The geometric loss 574 generally describes a geometric correlation between an estimated surface normal vector and partial derivatives of its position along a surface of the object as predicted by the surface map 528.

### Digital Image Decaling using an Overlay Object

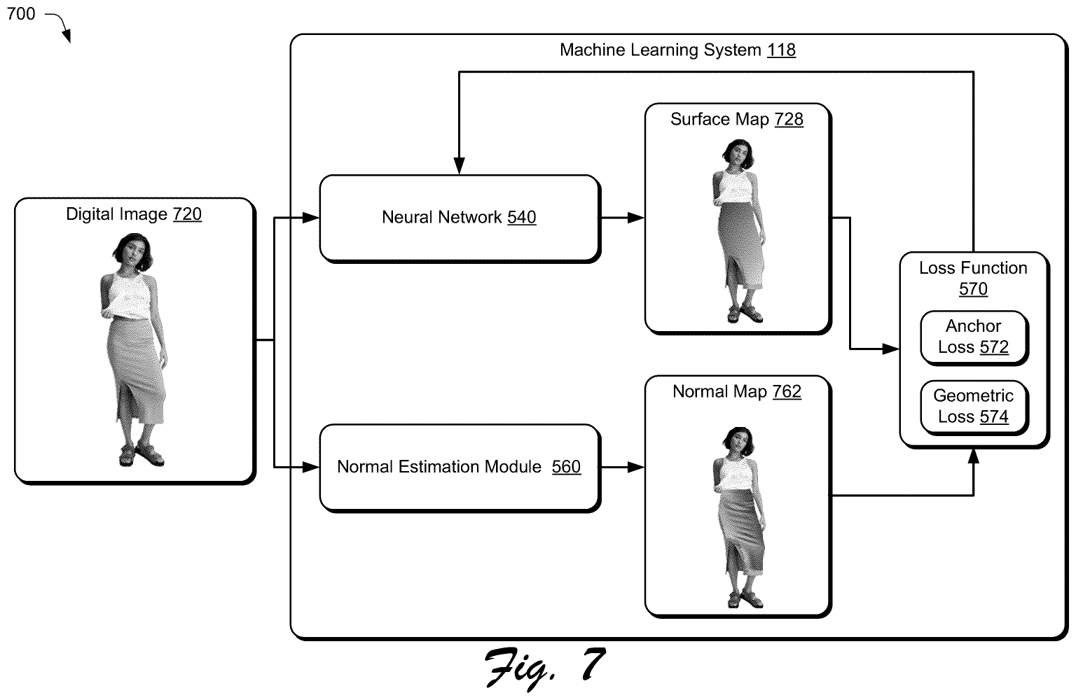

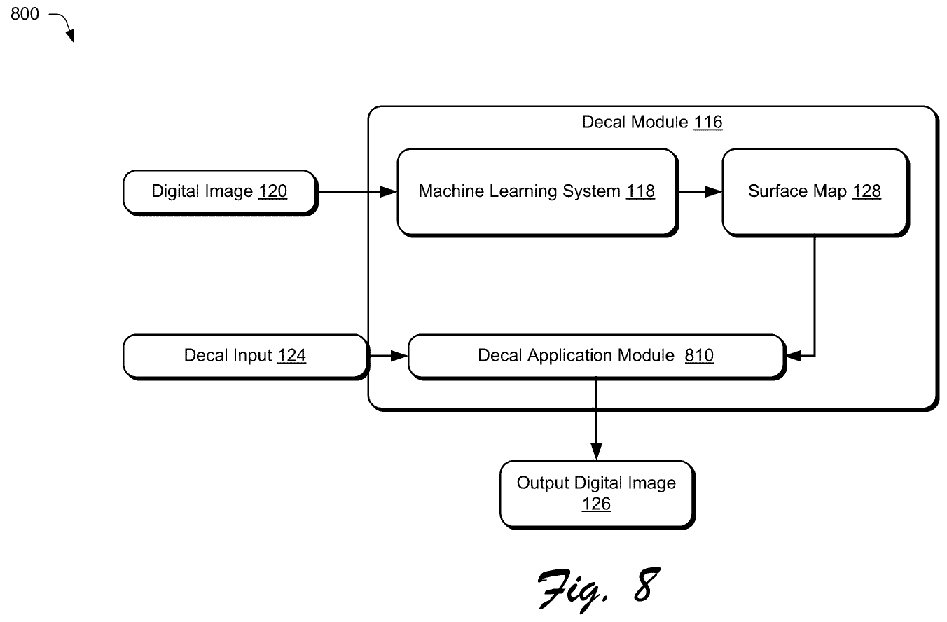

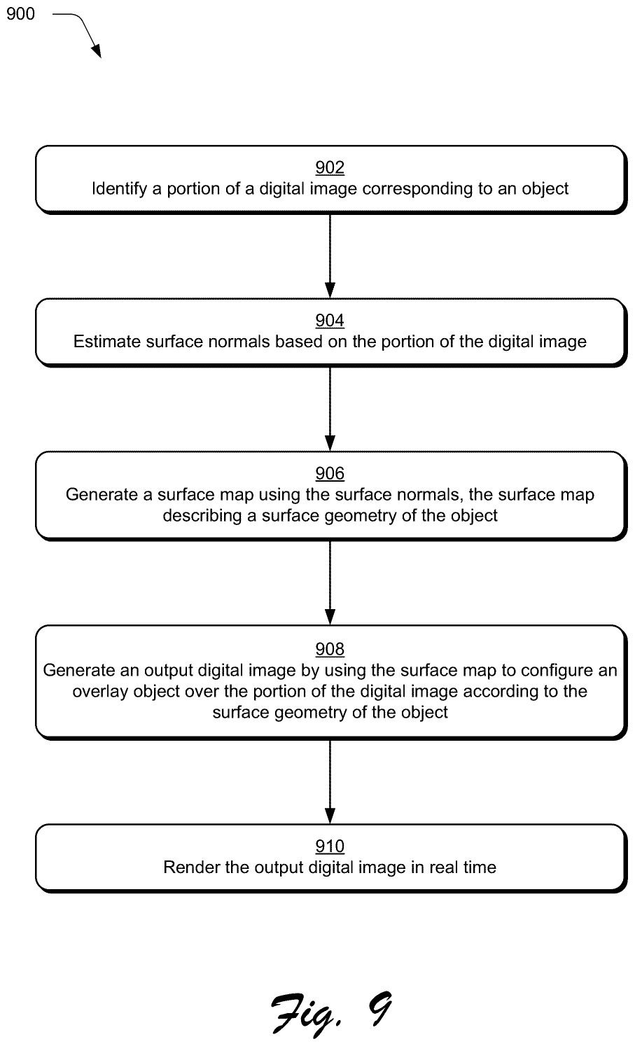

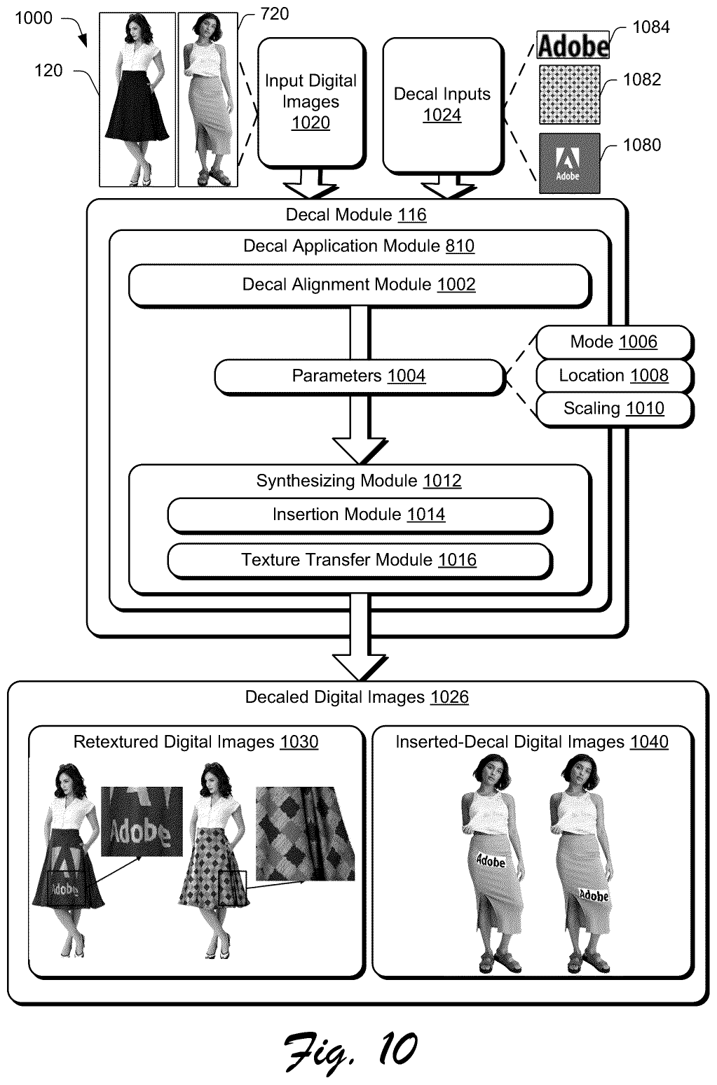

FIG. 7 depicts a system 700 in an example implementation showing operation of the machine learning system 118 of FIG. 1 in greater detail as using a digital image 720 as input to generate a surface map 728 by a model trained using training digital images of FIGS. 2-6. FIG. 8 depicts a system 800 in an example implementation showing operation of the machine learning system 118 of FIG. 1 in greater detail as decaling a digital image 120 based on the surface map 128 generated by a model trained using training digital images of FIGS. 2-6. FIG. 9 depicts a procedure 900 in an example implementation in which a surface map 128 generated using machine learning from a digital image 120 to be decaled is used with a decal input 124 to render a decaled output digital image 126. FIG. 10 depicts a system 1000 in an example implementation showing different types of decal output images generated using the machine learning system 118 of FIG. 1 based on a surface map.

The following discussion describes techniques that may be implemented utilizing the described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeably to FIGS. 7-10.

With reference to FIG. 7, the machine learning system 118 receives as an input a digital image 720 having an object (e.g., skirt garment) to be decaled and generates a surface map 728 for the object in the digital image 720. To do so, the machine learning system 118 uses the trained neural network 540 to predict the surface map 728 (e.g., “inference” stage) without necessarily receiving annotation data for the digital image 720 (e.g., similar to the annotation data 522 received during the “training” stage depicted in FIG. 5). Instead, the machine learning system 118 in the implementation of FIG. 7 predicts anchor point locations and surface map coordinates (e.g., UV coordinates) in the surface map 728 for the digital image 720.

For example, the normal estimation module 560 determines a normal map 762 (e.g., estimated surface normal vectors) for the digital image 720, and then the machine learning system 118 uses the loss function 570 to supervise the prediction of the surface map 728 by enforcing the anchor loss 572 (over the predicted anchor point positions) and the geometric loss 574 without receiving sparsely annotated data for the digital image 720.

The following equation describes an example implementation of enforcing or minimizing the anchor loss 572 (where the surface map 728 is a UV map):

$$Anchor loss = ‖ anchor\_xy - anchor\_UV ‖ ;$$

where ‘anchor_xy’ represents a predicted anchor point position at a predicted UV map 728, and ‘anchor_UV’ represents a corresponding “ground-truth” anchor point position in a reference UV map of a template object (e.g., in UV space 212 of the object model template).

In an example, the machine learning system 118 calculates the anchor loss 572 based on reference locations of the plurality of anchor points 206, 208, etc. (depicted in FIG. 2) in a reference surface map (e.g., UV space 212 of the object model template) and corresponding locations of the plurality of anchor points in the predicted surface map 728.

The following equation describes an example implementation of enforcing or minimizing the geometric loss 574 (where the surface map 728 is a UV map):

$$Geometric loss = ‖ {( \partial u / \partial x )}^{2} + {( \partial v / \partial x )}^{2} - 1 / {( cos β )}^{2} ‖ + ‖ {( \partial u / \partial y )}^{2} + {( \partial v / \partial y )}^{2} - 1 / ( {( cos β )}^{2} {( sin α )}^{2} ) ( {( cos α )}^{2} {( sin β )}^{2} + {( cos β )}^{2} ) ‖ + ‖ \partial u / \partial x \partial u / \partial y + \partial v / \partial x \partial v / \partial y - ( cos α sin β ) / ( sin α {( cos β )}^{2} ) ‖ ;$$

where (u, v) are coordinates of a surface normal vector in a 2D space (e.g., UV space 212); (x, y, z) are coordinates of the surface normal vector in a 3D space (e.g., from a perspective of a camera that captured the digital image 720); and (α, β) is an angular direction of the surface normal vector in the 3D space.

Thus, in examples, the machine learning system 118 calculates the geometric loss 574 based on the surface map 728 and the normal map 762.

With reference to FIG. 8, the machine learning system 118, as described in relation to FIG. 1, receives as an input a digital image 120 of an object (e.g., worn garment, etc.) to be decaled and a decal input 124, and outputs a decaled output digital image 126 that is consistent with a surface geometry of the object in the digital image 120. To do so, the decal module 116 includes a decal application module 810 that maps (e.g., “wraps”) the decal input 124 onto a surface geometry of the object indicated by the surface map 128.

For example, with reference to FIGS. 7-10, the machine learning system 118 identifies a portion of the digital image (e.g., 120 or 720) corresponding to the object (block 902). For instance, the normal estimation module 560 estimates surface normals based on the portion of the digital image that includes the object to generate the normal map 762 (block 904).

A surface map (e.g., 128 or 728) is then generated (block 906) using the surface normals, for example, by enforcing the anchor loss 572 and/or the geometric loss 574 to supervise prediction of the surface map 128 or 728. The decal application module 810 then generates the output digital image 126 (block 908) by using the surface map to configure an overlay object over the portion of the digital image according to the surface geometry of the object. For example, the where the decal input 124 is a texture map (e.g., 2D or flat texture map), the decal application module 810 maps portions of the texture map onto offset pixel locations in the digital image (and optionally adjusts shading, brightness, etc., characteristic thereof) so as to simulate projection of the texture map onto a 3D surface of the object when the texture map is overlayed on the digital image.

The output digital image 126 is then rendered in real time in a user interface 110 of a display device 112 (block 910). In this way, the decal application module 810 takes features from the decal input 124 and simulates wrapping them onto a surface geometry of the object in the digital image 120 by using the predicted surface map 128 or 728 (e.g., UV map) as an “unwrapped” version of the object in the digital image 120 to simulate an appearance of the decal input being “wrapped” or projected on a surface of the object.

In an implementation, with reference to FIG. 10, the system 1000 receives one or more input digital images 1020 and one or more decal inputs 1024. The decal inputs 1024 may include texture maps (e.g., texture maps 1080, 1082) and/or insertion images (e.g., insertion image 1084) that are to be applied to one or more of the input digital images 1020.

A decal alignment module 1002 of the decal application module 810 processes the input digital images 1020, decal inputs 1024, and/or other user input determine parameters 1004 for applying a decal onto the digital image(s) 1020. In an example, the parameters 1004 include a decal mode 1006 such: a retexturing mode where a decal is to be applied by transferring a texture map onto an object (e.g., retexturing), an insertion mode where a decal (e.g., insertion image 1084) is to be inserted at a specific location 1008, and/or scaling settings 1010 where a decal texture is to be stretched or repeated across the surface of the object.

A synthesizing module 1012 then processes the input digital image(s) 1020 and the decal input(s) 1024 to generate one or more decaled output digital images 1026. In an example, an insertion module 1014 of the synthesizing module 1012 synthesizes inserted-decal output digital images 1040 by inserting a warped version of the insertion digital image 1084 onto a surface of an object (e.g., garment) according to the surface geometry of the object, a user-defined location 1008, and/or a scaling (e.g., resizing) setting 1010.

In another example, a texture transfer module 1016 of the synthesizing module 1012 transfers a texture map 1080 onto the input digital image 120 to generate a retextured digital image 1030 where the decal 1080 is stretched across the surface of the object according to the scaling setting 1010; or a retextured digital image 1030 where the texture map 1082 is transferred onto the surface of the object by repeating or cropping a pattern of the texture map 1082 to generate the retextured digital image 1030. Other implementations or variations based on the parameters 1004 are possible.

### Example System and Device

FIG. 11 illustrates an example system generally at 1100 that includes an example computing device 1102 that is representative of one or more computing systems and/or devices that may implement the various techniques described herein. This is illustrated through inclusion of the decal module 116. The computing device 1102 may be, for example, a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1106 is illustrated as including memory/storage 1112. The memory/storage 1112 represents memory/storage capacity associated with one or more computer-readable media. The memory/storage component 1112 may include volatile media (such as random access memory (RAM)) and/or nonvolatile media (such as read only memory (ROM), Flash memory, optical disks, magnetic disks, and so forth). The memory/storage component 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also serve to abstract scaling of resources to provide a corresponding level of scale to encountered demand for the resources 1118 that are implemented via the platform 1116. Accordingly, in an interconnected device embodiment, implementation of functionality described herein may be distributed throughout the system 1100. For example, the functionality may be implemented in part on the computing device 1102 as well as via the platform 1116 that abstracts the functionality of the cloud 1114.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
identifying, by a processing device, a portion of a digital image corresponding to an object;
estimating, by the processing device, surface normals based on the portion of the digital image;
generating, by the processing device, a surface map using the surface normals, the surface map describing a surface geometry of the object; and
generating, by the processing device, an output digital image by using the surface map to configure an overlay object over the portion of the digital image according to the surface geometry of the object.

2. The method of claim 1, wherein the generating the output digital image includes overlaying an insertion digital image onto the digital image according to the surface geometry of the object.

3. The method of claim 1, wherein the generating the output digital image includes using the surface map to transfer a texture map into the digital image according to the surface geometry of the object.

4. The method of claim 1, wherein the estimating the surface normals includes generating a normal map that maps the surface normals to pixels in the portion of the digital image.

5. The method of claim 1, wherein the generating the surface map is performed using a neural network of a machine learning system.

6. The method of claim 1, further comprising calculating a geometric loss, using a loss function implemented by a neural network, based on the estimated surface normals and the surface map,
wherein the generating the surface map includes predicting the surface map using the neural network based on the loss function.

7. The method of claim 1, wherein the surface map is a UV map that maps the portion of the digital image to a surface of a three-dimensional (3D) object model.

8. The method of claim 7, further comprising:
determining, by the processing device, that the object belongs to a category of objects; and
rendering, by the processing device, a mesh template associated with the category of objects as the 3D object model.

9. A system comprising:
a normal estimation module implemented by a processing device to estimate surface normals based on a portion of a digital image corresponding to an object;
a machine learning system implemented by the processing device to generate a surface map using the surface normals, the surface map describing a surface geometry of the object; and
a synthesizing module implemented by the processing device to generate an output digital image by using the surface map to configure an overlay object over the portion of the digital image according to the surface geometry of the object.

10. The system of claim 9, further comprising:
a texture transfer module implemented by the processing device to transfer a texture map into the portion of the digital image according to the surface geometry of the object.

11. The system of claim 9, further comprising:
an insertion module implemented by the processing device to overlay an insertion digital image onto the digital image according to the surface geometry of the object.

12. A method comprising:
selecting, by a processing device, a portion of a digital image corresponding to an object;
generating, by the processing device, a normal map indicating estimated surface normals based on the portion of the digital image;
obtaining, by the processing device, annotation data indicating a plurality of anchor points and pixel locations in the digital image corresponding to the plurality of anchor points; and
training, by the processing device, a machine learning system to predict a surface map of the object based on the digital image, the annotation data, and the normal map,
the surface map describing a surface geometry of the object.

13. The method of claim 12, further comprising:
rendering, by the processing device, a mesh template associated with a category of objects to generate a three-dimensional (3D) object model, wherein the object depicted in the portion of the digital image belongs to the category of objects; and
defining, by the processing device, the plurality of anchor points based on the rendering of the mesh template.

14. The method of claim 12, wherein the selecting the portion of the digital image includes generating an image mask having an unmasked region that overlaps the portion of the digital image.

15. The method of claim 14, further comprising estimating, by the processing device, the pixel locations that correspond to the plurality of anchor points based on the image mask and a rendering of a three-dimensional (3D) object model.

16. The method of claim 12, further comprising annotating, by the processing device, the digital image to indicate the selected portion of the digital image and the pixel locations corresponding to the plurality of anchor points, wherein the obtaining the annotation data comprises the annotating the digital image.

17. The method of claim 16, wherein the training the machine learning system is further based on the annotated digital image.

18. The method of claim 12, further comprising calculating an anchor loss, using a loss function implemented by a neural network of the machine learning system, based on reference locations of the plurality of anchor points in a reference surface map and corresponding locations of the plurality of anchor points in the predicted surface map,
wherein the training the machine learning system is further based on the loss function.

19. The method of claim 12, further comprising calculating a geometric loss, using a loss function implemented by a neural network of the machine learning system, based on the surface map and the normal map,
wherein the training the machine learning system is further based on the loss function.

20. The method of claim 12, wherein the surface map is a UV map that maps the portion of the digital image to a surface of a three-dimensional (3D) object model.
